(19) United States
(12) Patent Application Publication
(10) Pub. No.: US 2016/0187308 A1
(43) Pub. Date: Jun. 30, 2016

(54) METHOD AND SYSTEM FOR DETECTING BORON IONS USING ION CHROMATOGRAPHY FOR ONLINE MONITORING OF STEAM GENERATOR TUBE LEAKAGE IN LIGHT WATER REACTOR

(71) Applicant: Huvis Water Corporation, Ansan-si (KR)

(72) Inventors: Duk Won KANG, Seongnam-si (KR); Jong Suk PARK, Gwangju (KR); Seung Il KIM, Incheon (KR); Se Ban LEE, Seoul (KR)

(73) Assignee: Huvis Water Corporation, Ansan-si (KR)

(21) Appl. No.: 14/582,880

(22) Filed: Dec. 24, 2014

(51) Int. Cl. G01N 30/96; G01M 3/40; G01N 30/86; G01N 30/16

(52) U.S. Cl. CPC G01N 30/96; G01N 30/16; G01M 3/40; G01N 30/8675

(57) ABSTRACT

The present invention relates to an online leakage monitoring technique of a steam generator tube for monitoring leakage of the steam generator tube by analyzing concentration of an extremely small amount of boron ions in the secondary side solution of the steam generator in which a variety of ions are mixed, and the present invention is effective in that concentration of an extremely small amount of boron ions can be accurately detected, maintenance is convenient and durability is improved since analysis time is reduced considerably and operation pressure is lowered greatly by using ion chromatography provided with a boron trapping column optimized for trapping an extremely small amount of boron ions and a deionization water supplier for rising a sample line, instead of general ion chromatography provided with a concentration column and a separation column.

### BACKGROUND OF THE INVENTION

1. Field of the Invention

The present invention relates to a method and system for detecting boron ions using ion chromatography, and more specifically, to a method and system for detecting boron ions, which can detect even an extremely small amount of boron ions by separating and concentrating only the boron ions from secondary system water using ion chromatography in order to monitor leakage of a steam generator tube in a light water reactor online in real-time.

2. Background of the Related Art

As a method currently used for monitoring leakage and a leak rate of a steam generator tube in a Pressurized Light Water Reactor (PWR), there are a method of using ¹⁶N, a method of using an inert gas such as ¹³³Xe, a method of improving leakage monitoring sensitivity and measuring a leakage after increasing concentration of ⁴¹Ar by artificially injecting ⁴⁰Ar into a reactor coolant system (RCS), and a method using ³H concentration of steam generator blowdown.

However, since the [Primary-to-Secondary Leak Monitoring Guideline] published by Electric Power Research Institute (EPRI) of USA in 1995 recommends to apply a ¹⁶N monitoring method, most of light water reactors install a ¹⁶N monitoring apparatus at the main steam output terminal of a steam generator and monitor leakage and a leak rate of a steam generator tube.

The ¹⁶N monitoring method is disadvantageous in that it cannot be used when operation of the reactor is stopped or output power of the reactor is less than 20% since neutron flux is not formed sufficiently because the half-life of ¹⁶N is very short although the measurement sensitivity is superior. Actually, an incident of leaking 45 m³ of reactor coolant occurred at Uljin unit 4 in 2002 since a rupture in a steam generator tube is not immediately sensed and blocking of the steam generator is delayed when the leakage monitoring capability of the ¹⁶N leakage monitor is lost while output of the reactor is stopped due to overhaul of the reactor.

An inert radioactive gas (Ar-41, Kr-85m, Kr-88, Kr-87, Xe-133, Xe-135, Xe-135m or the like), which is a radionuclide among reactor coolants, is used in a method using an inert radioactive gas as a released gas of a condenser, and a gross beta (β) radiation monitor is installed in a steam jet air ejector system of a condenser off-gas system or a vacuum pump system using offline sampling to calculate a leak rate by measuring gross beta radiation of these. Although such a monitoring method may monitor leakage even when the output power of the reactor is less than 20% since the half-life of the inert radioactive gas is relatively long compared with that of ¹⁶N, it is disadvantageous in that a leaking point cannot be grasped since it is greatly affected by the damage of nuclear fuel when the gross beta radiation is measured.

Although the ⁴¹Ar monitoring method applied in the Diablo Canyon nuclear power plant and the Comanche Peak nuclear power plant of USA has an advantage of improving reliability of leak rate evaluation since a leak rate can be evaluated by measuring ⁴¹Ar leaked out from the system while controlling concentration of ⁴¹Ar in an activation furnace system controlled by neutrons to a predetermined concentration level by artificially injecting ⁴⁰Ar into the reactor coolant system (RCS) and, in addition, the leak rate may be calculated for a considerably extended period of time even after a tube leak occurs since the half-life thereof is long, it is disadvantageous in that operators of the nuclear power plant are reluctant to artificially increasing radioactivity in the system, and it is difficult to point out a leaking steam generator when a leak occurs since the leakage is integratingly monitored, and thus when a leak is sensed, samples should be independently collected and analyzed for each steam generator as a subsequent step.

The ³H monitoring method is a technique of monitoring leakage by measuring radioactivity of tritium in a liquid phase sample released as blowdown, and although it is advantageous in that hide-out, hideout return or the like does not need to be considered and accuracy thereof is superior, it is disadvantageous in that a long time is required to reach an equilibrium state due to the long half-life and, accordingly, sensitivity to a new leakage generation is lowered.

Since such a technique of monitoring leakage of a steam generator generally employed by nuclear power plants all over the world is a technique using a specific radionuclide (¹⁶N, ³H, Xe and the like) created by nuclear fission and is disadvantageous in that it can be used only when output power of a reactor is higher than 20%, development of a new technique is required to overcome such a limitation. As described above, each of the monitoring methods using a radionuclide has advantages and disadvantages and is limited in using the method. In order to overcome such a limitation, a technique of monitoring leakage of boron (B) or lithium (L) ions, which are nonradionuclides, contained in a coolant, i.e., primary system water, is emerged as an alternative.

Although the steam generator tube leakage guideline of the Electric Power Research Institute (EPRI) of USA describes that leakage of a steam generator tube can be monitored if an extremely small amount of lithium (Li) ions and boron (B) ions can be analyzed online using ion chromatography, only its possibility is presented since it is described that only analysis of some ppm (parts per million) level is possible until present.

Presently, concentration of boron in a coolant of a reactor is measured at all times to control output power of the reactor while a power plant is in a normal operation, and neutralimetry using mannitol is used to enhance measurement sensitivity. However, this analysis method has a limit in that only ppm level measurements can be performed.

Meanwhile, an online boron monitoring method of Generic Electric (GE) used among semiconductor companies may perform a measurement of about 5 to 20 ppb on condition that resistivity of incoming water is 15MΩ or higher. However, in the case of a nuclear power plant, since large amounts of hydrazine (N₂H₄), ammonia (NH₃), ethanolamine (ETA, NH₂CH₂CH₂OH) and the like are contained in the secondary system water in addition to boron ions which are a measurement target, it is difficult in reality to attain a quality of water having resistivity of 15MΩ or higher and measure the boron ions.

As described above, although interest in using the boron ions or the lithium ions, which are inactive chemical species contained in the reactor coolant system (RCS) at a predetermined concentration, as an indicator is greatly increased due to the problems of the conventional monitoring techniques, it is very difficult to continuously measure and monitor an extremely small amount of boron or lithium ions since, when the boron ions or the lithium ions existing in the primary system water at a concentration of ppm are leaked to the secondary side, the boron ions or the lithium ions are diluted at the secondary side and concentration is lowered to a ppb or ppt (parts per trillion) level.

The inventors of the present invention applied for a patent entitled ^{┌}Method of monitoring leakage of steam generator tube in nuclear power plant using boron ions, and monitoring system thereof_{┘} as a result of an effort for developing a technique for overcoming the limit of steam generator leakage monitoring suffered by light water reactors and acquired Korean Patent Registration No. 10-1285530 (Jul. 5, 2013).

However, the invention of Patent Registration No. 10-1285530 separately needs a pre-treatment step and a degassing step for purification of a test sample to analyze conductivity of the sample, and since boron can be detected through a pre-treatment process only when the resistivity is 15MΩ or higher, a large quantity of microfiltration filters and a lot of time are required as a processing condition close to ultra-purity. In addition, it is disadvantageous in that since ammonia, hydrazine, ethanolamine and the like, in addition to a small amount of boron ions, are contained in the secondary system water of a nuclear power plant, it is difficult in reality to obtain a quality of water higher than 15MΩ.

Meanwhile, if general ion chromatography provided with a concentration column and a separation column is used to detect an extremely small amount of boron ions contained in a mixed phase solution, it requires twenty or more minutes, and thus this is inadequate as an on-site apparatus for online monitoring and disadvantageous for durability of the system and maintenance of the apparatus since operation pressure is maintained high at all times as a long separation column (9×250 mm) filled with anion exchange resin having a particle size of 7.5 to 11 μm is used.

### SUMMARY OF THE INVENTION

Therefore, the present invention has been made in view of the above problems, and it is an object of the present invention to provide a method and system for detecting boron ions, which can promptly and accurately detect boron ions and a concentration thereof without requiring pre-treatment of system water of a nuclear power plant close to ultra-purity and without maintaining high pressure in the system.

To accomplish the above object, according to one aspect of the present invention, there is provided a system for detecting boron ions using ion chromatography for online monitoring of steam generator tube leakage in a light water reactor, the system including a sample line for injecting and flowing a sample, pre-treatment filters for removing particulate foreign matters in the sample, pressure sensors for determining saturation of the pre-treatment filters, a flowmeter for monitoring a flow speed and a flow rate of the sample flowing through the sample line, ion chromatography for measuring conductivity of the sample, being provided with a boron trapping column optimized for trapping an extremely small amount of boron ions and a deionization water supplier for rinsing the sample line, and a sample container for controlling a flow speed and a flow rate of the sample flowing into the ion chromatography.

The ion chromatography 30 includes: a sample supplier for supplying a sample, a standard solution supplier for supplying a standard solution, a deionization water supplier for supplying deionized water, sample pumps and sample valves for supplying the sample, the standard solution and the deionized water, a 10-port valve and inline filters for removing particulate foreign matters of fine particles in the sample, a 6-port valve and a boron trapping column for trapping and concentrating boron ions in the sample, an eluent supplier and an eluent pump for supplying eluent for promoting transfer of the sample, a deionization water supplier and a deionization water pump for rinsing impurities of all kinds of ions, other than the boron ions, remaining in the sample line, an anion suppressor for easily detecting the boron ions by removing residual cations, lowering conductivity of the eluent and increasing conductivity of the sample, a conductivity detector for detecting conductivity of the boron ions in the sample, and waste lines for exhausting waste fluids.

A method of detecting boron ions using ion chromatography for online monitoring of steam generator tube leakage in a light water reactor includes a sample injection step of injecting a sample into the system, a sample pre-treatment step of removing particulate foreign matters in the injected sample, a conductivity measurement step of measuring conductivity of the boron ions using ion chromatography provided with a boron trapping column optimized for trapping an extremely small amount of boron ions and a deionization water supplier for rinsing the sample line, and an analysis and evaluation step of calculating concentration of the boron ions, detecting symptoms of leakage of the steam generator tube, and calculating a leak rate by analyzing the measured conductivity.

Meanwhile, the process of measuring conductivity of the boron ions using the ion chromatography includes a sample flow-in step, an automatic filtering step of automatically removing particulate foreign matters of fine particles in the flowed-in sample, a boron ion trapping step of concentrating only the boron ions in the flowed-in sample, a sample line rinsing step of removing impurities of all kinds of ions other than the boron ions by rinsing the sample line, an eluent injecting step of dissociating the trapped boron ions and pushing the dissociated boron ions into a suppressor and a conductivity detector, a cation removing step of removing a small amount of cations still remaining in the sample, and a conductivity measurement step of measuring conductivity of the boron ions in the processed sample.

### BRIEF DESCRIPTION OF THE DRAWINGS

FIG. 1 is a view showing the configuration of a boron ion detecting system of the present invention.

FIG. 2 is a view showing the configuration of ion chromatography of the present invention.

FIG. 3 is a view showing the configuration of a boron ion detecting method of the present invention.

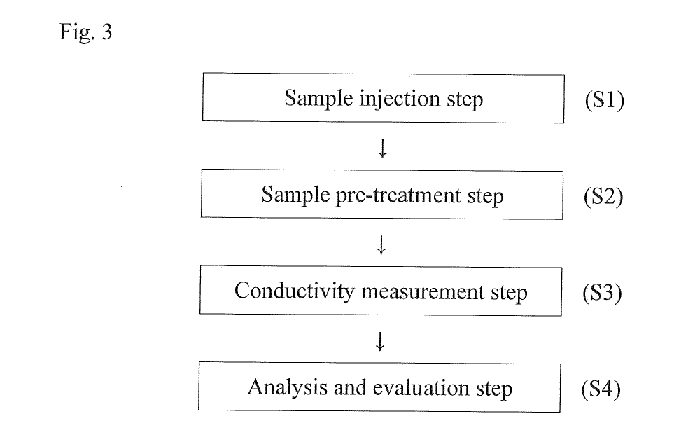

FIG. 4 is a flowchart illustrating the procedure of measuring conductivity of boron ions using ion chromatography of the present invention.

FIG. 5 is a flow diagram illustrating movement of fluid related to a mass for deriving an overall mass balance equation using a steam generator as a boundary surface in the present invention.

FIGS. 6 and 7 are views showing results of ion analysis using an ion separation column.

FIG. 8 is a view showing a structure combining sorbitol, which is a polyhydric alcohol, and boron.

### DESCRIPTION OF SYMBOLS

1: Sample Line
2a, 2b, 2c, 2d, 2e, 2f, 2g: Solenoid Valve
3a, 3b: Pressure Sensor
4a, 4b: Pre-treatment Filter
5: Flowmeter
6: Sample Container
7: Eluent Supplier
8a, 8b: Sample Pump
8c: Eluent Pump
8d: Deionization Water Pump
9: 6-port Valve
10: Boron Trapping Column
11: Anion Suppressor
12: Conductivity Detector
13: Drain
14a, 14b: Sample Valve
15: 10-port valve)
16a, 16b: Inline filter
17a, 17b, 17c: Waste Line
18: Deionization Water Supplier
19: Sample Supplier
20: Standard Solution Supplier
21: Deionization Water Supplier
30: Ion Chromatography

### DETAILED DESCRIPTION OF THE PREFERRED EMBODIMENT

Boron used for output control of a reactor exists as boron ions at a concentration of a wide range of 10 to 2,500 ppm in the primary side coolant of a steam generator for heat exchange. When the primary side coolant is leaked to the secondary side due to damage of a steam generator tube, the boron ions are diluted to ppb level and exist on the secondary side at a concentration of an extremely small amount.

The present invention is a monitoring technique using the boron ions existing on the secondary side of the steam generator of a reactor at a concentration of an extremely small amount like this as a leakage indicator of the steam generator tube and uses ion chromatography provided with a boron trapping column optimized for trapping an extremely small amount of boron ions and a deionization water supplier for rinsing a sample line in order to detect the boron ions existing on the secondary side of the steam generator of a reactor.

If general ion chromatography provided with a concentration column and a separation column is used to detect an extremely small amount of boron ions contained in a mixed phase solution, it takes a lot of time, and, therefore, this is inadequate as an on-site apparatus for online monitoring and disadvantageous for durability of the system and maintenance of the apparatus since operation pressure is maintained high at all times as a long separation column filled with anion exchange resin is used.

In addition, in the case of the patent of 10-1285530, a large quantity of filters and a filtering system are used to remove cations and anions hindering analysis of boron ions, and an ultrapure state like in a semiconductor manufacturing process should be maintained since the boron ions can be detected only in a condition of water quality of 15MΩ or higher.

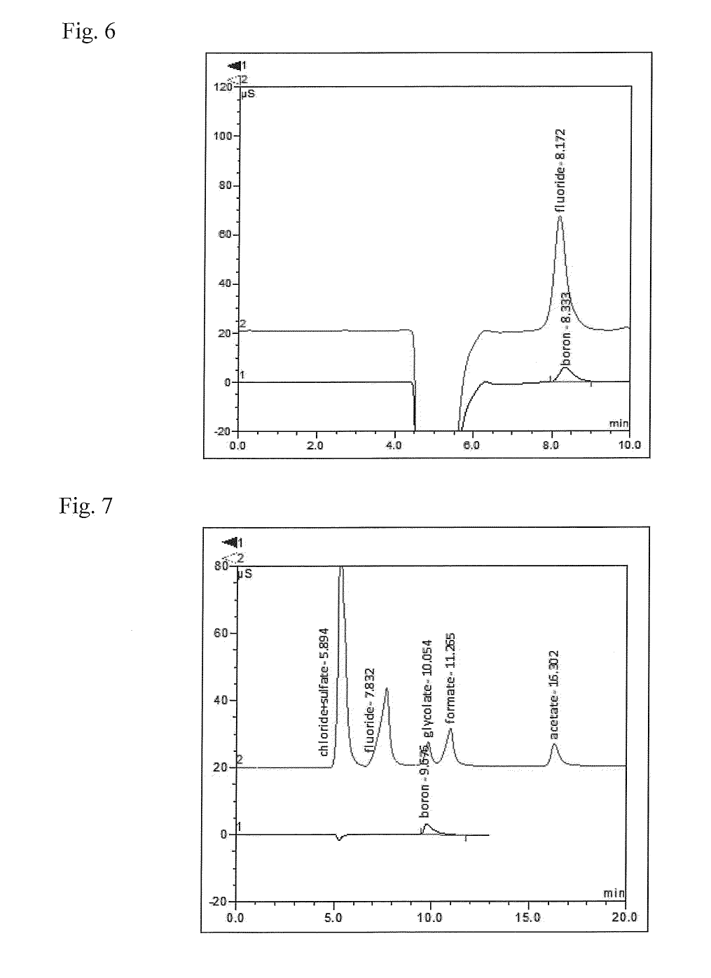

Meanwhile, although it is attempted to detect boron ions existing in mixed ions by using a separation column like in a method of the prior art after making mock-up system water like the secondary system water of a nuclear power plant, it is difficult to detect the boron ions since the peak of the boron ions is overlapped with the peaks of fluoride (F) and glycolate as shown in FIGS. 6 and 7.

In the present invention, a boron trapping column specialized for trapping an extremely small amount of boron ions and a rinse mode are employed to solve the problem of overlapping with each other like this, and after trapping only the boron ions into the boron trapping column, impurities of all kinds of ions other than the boron ions existing in the sample line are removed through a rinse step of injecting deionized water.

Like this, the present invention may accurately detect concentration of an extremely small amount of boron ions by employing a boron trapping column optimized for trapping an extremely small amount of boron ions, and maintenance is convenient and durability is improved since analysis time is reduced considerably and operation pressure is lowered greatly by using ion chromatography provided with a boron trapping column optimized for trapping an extremely small amount of boron ions and a deionization water supplier for rising a sample line, instead of general ion chromatography provided with a concentration column and a separation column, and in addition, the problem of overlapping the boron ions with fluoride and other anions is solved by using sorbitol, which is a new polyhydric alcohol, instead of conventional mannitol as an additive for amplifying conductivity of boron.

Hereinafter, the present invention will be described in detail with reference to the accompanying drawings of the embodiment.

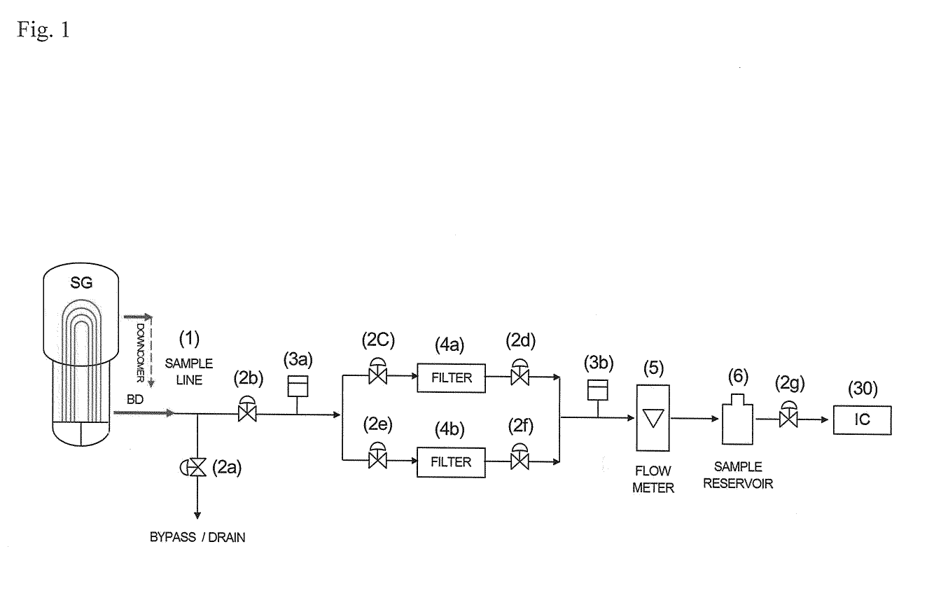

As shown in FIG. 1, a system for detecting boron ions using ion chromatography for online monitoring of steam generator tube leakage in a light water reactor of the present invention includes a sample line 1 for injecting and flowing a sample, pre-treatment filters 4a and 4b for removing particulate foreign matters in the sample, pressure sensors 3a and 3b for determining saturation of the pre-treatment filters 4a and 4b, a flowmeter 5 for monitoring a flow speed and a flow rate of the sample flowing through the sample line 1, ion chromatography 30 for measuring conductivity of the sample, being provided with a boron trapping column optimized for trapping an extremely small amount of boron ions and a deionization water supplier for rinsing the sample line, and a sample container 6 for controlling a flow speed and a flow rate of the sample flowing into the ion chromatography 30.

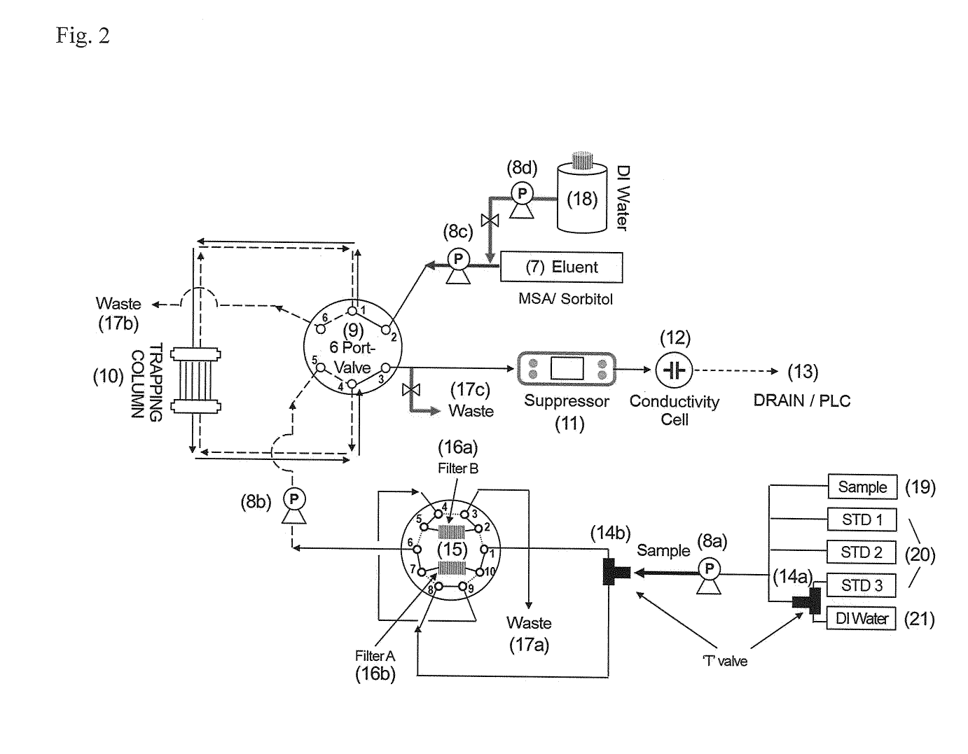

As shown in FIG. 2, the ion chromatography 30 includes a sample supplier 19 for supplying a sample, a standard solution supplier 20 for supplying a standard solution, a deionization water supplier 21 for supplying deionized water, sample pumps 8a and 8b and sample valves 14 and 14n for supplying the sample, the standard solution and the deionized water, a 10-port valve 15 and inline filters 16a and 16b for removing particulate foreign matters of fine particles in the sample, a 6-port valve 9 and a boron trapping column 10 for trapping and concentrating boron ions in the sample, an eluent supplier 7 and an eluent pump 8c for supplying eluent for promoting transfer of the sample, a deionization water supplier 18 and a deionization water pump 8d for rinsing impurities of all kinds of ions, other than the boron ions, remaining in the sample line 1, an anion suppressor 11 for easily detecting the boron ions by removing residual cations, lowering conductivity of the eluent and increasing conductivity of the sample, a conductivity detector 12 for detecting conductivity of the boron ions in the sample, and waste lines 17a, 17b and 17c for exhausting waste fluids.

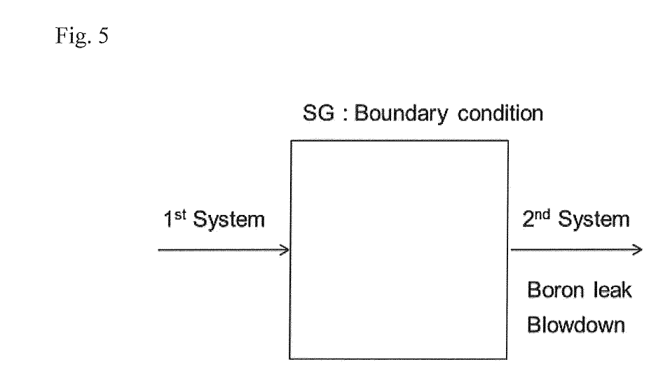

On the other hand, as shown in FIG. 5, a method of detecting boron ions using ion chromatography for online monitoring of steam generator tube leakage in a light water reactor of the present invention includes a sample injection step (S1) of injecting a sample into the system, a sample pre-treatment step (S2) of removing particulate foreign matters in the injected sample, a conductivity measurement step (S3) of measuring conductivity of the boron ions using ion chromatography provided with a boron trapping column optimized for trapping an extremely small amount of boron ions and a deionization water supplier for rinsing the sample line, and an analysis and evaluation step (S4) of calculating concentration of the boron ions, detecting symptoms of leakage of the steam generator tube, and calculating a leak rate by analyzing the measured conductivity.

The sample injection step (S1) is a step of injecting a sample from system water to the system, and as shown in FIG. 1, the sample is injected through the sample line 1. [The sample injected like this flows into the ion chromatography 30 by way of the pre-treatment filters 4a and 4b, the flowmeter 5 and the sample container 6 passing through the following steps and then exhausted to the drain 13.]

At the pre-treatment step (S2), particulate foreign matters in the flowed-in sample are removed by the pre-treatment filters 4a and 4b. The pre-treatment filters 4a and 4b are configured to be installed as a pair in parallel so that, when a pre-treatment filter 4a or 4b flowing the sample is saturated, flow of the sample may be automatically by-passed through another pre-treatment filter 4a or 4b.

The pressure sensors 3a and 3b are installed before and after the pre-treatment filters 4a and 4b to determine saturation of the pre-treatment filters 4a and 4b. Pressures checked by the pressure sensors 3a and 3b are monitored at a monitor, and it is configured to automatically flow the sample through a pre-treatment filter 4a or 4b of another side if the pressure increases as much as a preset pressure difference ΔP so that operation can be continued without interruption. In addition, the flowmeter 5 is installed to monitor at all times a flow rate of the sample flowing into the ion chromatography 30 from the secondary system water.

The sample container 6 is installed before the ion chromatography 30. Since the speed and flow rate of the sample flowing into the system are different from the speed and flow rate of the sample flowing into the ion chromatography 30, the sample container 6 is needed.

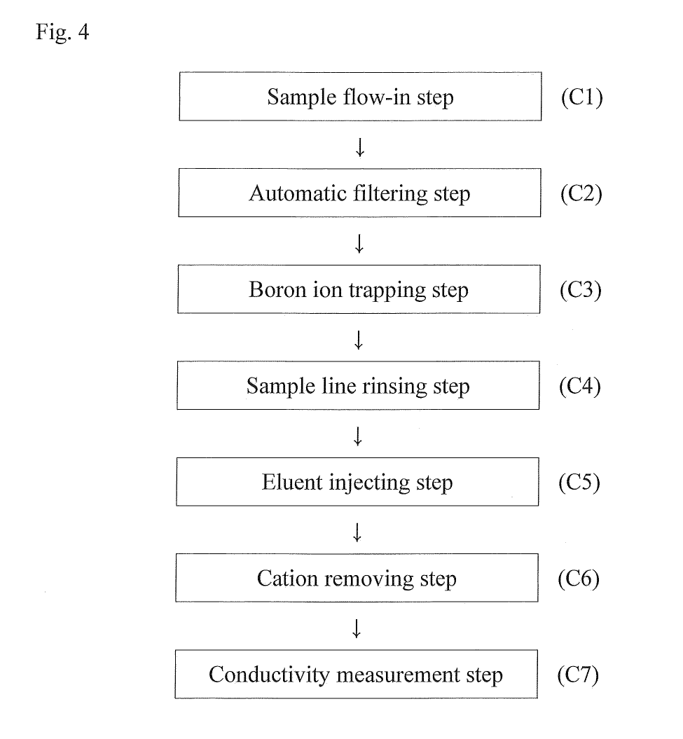

At the conductivity measurement step (S3), conductivity of the boron ions in the sample flowing in through the pre-treatment step (S2) is measured using the ion chromatography 30. As shown in FIG. 4, the process of measuring conductivity of the boron ions using the ion chromatography includes a sample flow-in step (C1), an automatic filtering step (C2) of automatically removing particulate foreign matters of fine particles in the flowed-in sample, a boron ion trapping step (C3) of concentrating only the boron ions in the flowed-in sample, a sample line rinsing step (C4) of removing impurities of all kinds of ions other than the boron ions by rinsing the sample line, an eluent injecting step (C5) of dissociating the trapped boron ions and pushing the dissociated boron ions into a suppressor and a conductivity detector, a cation removing step (C6) of removing a small amount of cations still remaining in the sample, and a conductivity measurement step (C7) of measuring conductivity of the boron ions in the processed sample.

The sample flow-in step (C1) is a step of flowing in a sample from the sample container 6 through the sample supplier 19, and the sample is flowed in after injecting standard solutions STD 1, 2 and 3 first and measuring conductivity of each of the standard solutions. The standard solutions are pure boron ion solutions respectively having a different concentration and move from the standard solution supplier 20 to the sample pump 13a, the sample valve 14a (the upper one), the 10-port valve 15, the inline filter 16a, the sample pump 8b, the 6-port valve 9 and the boron trapping column 10.

In this process, the particulate foreign matters of fine particles in the standard solutions are filtered by the inline filters 16a and 16b and exhausted to the waste line 17a. In addition, the boron trapping column 10 traps only boron ions, and impurities containing cations such as hydrazine, ammonia, ethanolamine and the like other than the boron ions existing in the secondary system water are exhausted to the waste line 17c. In addition, impurities other than the boron ions remaining inside the tube are removed by rinsing inside of the tube of the system using deionized water supplied from the deionization water supplier 18.

Then, the standard solutions are moved to the anion suppressor 11 by the eluent supplied from the eluent supplier 7, and if there are cations that have not been removed yet, they are removed by the anion suppressor 11. Subsequently, the standard solutions arrive at the conductivity detector 23, and if the standard solutions arrive at the conductivity detector 23, the conductivity detector 23 measures conductivity and sets the conductivity as a reference value (a calibration curve) for detecting boron ions.

Such standard solutions are not always injected, and if it is set to automatically inject a standard solution and measure conductivity in different time slots for injection of an online method through the sample pump 8a and automatic calibration of the measured value, accuracy of the measured value can be enhanced.

After measuring conductivity of the standard solutions and setting a reference value for each concentration, a sample is injected using the sample pump 8a. T-valves are preferably used as the sample valves 14a and 14b for online injection of the sample, the standard solutions and the deionization water through the sample pump 8a and automatic movement of the measured conductivity values of the standard solutions to the automatic calibration and automatic filtering steps.

The automatic filtering step (C2) is a step of automatically removing the particulate foreign matters of fine particles in the injected sample, and the particulate foreign matters in the sample are successively filtered while the sample flowing in through the sample pump 8a passes through an inline filter 16a or 16b among the two inline filters 16a and 16b connected to the 10-port valve 15 by way of the sample valve 14b, and the removed particulate foreign matters are exhausted to the waste line 17a.

The pore sizes of the inline filters 16a and 16b are preferably 0.3 to 0.5 μm, and deionized water is injected into unused another inline filter 16a or 16b from the deionization water supplier 21 through the sample valve 14a to rinse the inline filter, and the rinsing water is exhausted to the waste line 17a. It is configured to automatically pass the sample through another inline filter 16a or 16b if difference of pressure of the used inline filter 16a or 16b increases. Like this, it is configured to alternatively pass the sample through the inline filters 16a and 16b so that the step of filtering the sample may be continuously performed.

At the boron ion trapping step (C3), boron ions in the sample are trapped and concentrated into the boron trapping column 10. The boron trapping column 10 is a concentration column optimized for trapping an extremely small amount of boron ions, in which the boron ions are compressed with a high pressure so that the concentration column may not have an empty space therein, and only the boron ions are selectively trapped and concentrated. Such a boron trapping column 10 is mounted on the 6-port valve 9. Polyol, which is an alcohol having three or more hydroxyl groups (OH⁻) in a molecule, is used as a filler of the boron trapping column 10.

At the sample line rinsing step (C4), impurities of all kinds of ions other than the boron ions are removed by rinsing the sample line 1 inside the ion chromatography 30 using deionized water. Impurities of all kinds of ions other than the boron ions existing in the sample line 1 inside the ion chromatography 30 are removed by supplying deionized water from the deionization water supplier 18 immediately before injection of eluent (inject mode) after trapping and concentrating the boron ions in the sample into the boron trapping column 10, and the removed impurities are exhausted to the waste line 17c. Such a rinsing process is performed for about 1 to 5 minutes using the deionization water pump 8d configured of a micro pump having a flow rate of 1 to 5 mL/min, and a flow rate of the deionized water used at this point is about 1 to 5 ml/min.

At the eluent injecting step (C5), methane sulfonic acid (MSA) and sorbitol are injected into the boron trapping column 10. The MSA, which is eluent, is injected in a concentration range of 1 to 5 mM, and the sorbitol, which is an additive, is injected in a concentration range of 20 to 40 g/L.

Generally, as a method of increasing conductivity of boron ions, mannitol is added to eluent and reacted with borate. If the mannitol combines with boron, a compound of a new type is formed, and conductivity is amplified compared with the conductivity of the boron alone, and thus the mannitol is used as an additive.

However, since fluoride (F) ions of approximately 0.01 mg/L or less exist in the primary system water and, as shown in FIGS. 6 and 7, the peak of the boron ions is overlapped with the peak of the fluoride (F) ions, in the present invention, the sorbitol having the highest responsiveness with the boron ions among polyhydric alcohols is injected as an additive described above in a concentration range of 20 to 40 g/L.

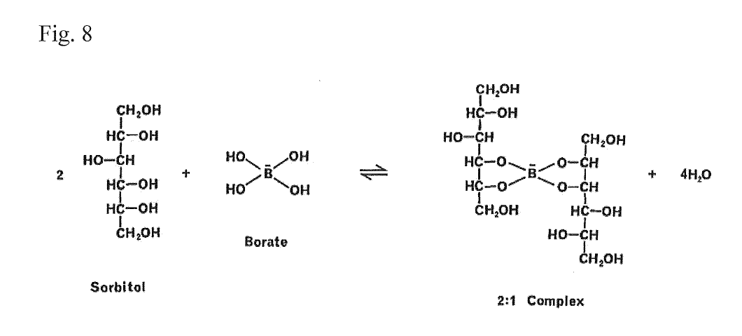

Table 1 shows response rates and resolution rates of boron with respect to polyhydric alcohols, and FIG. 8 is a view showing a bonding structure of sorbitol and boron.

TABLE 1

| Sugar alcohol | | |
|---|---|---|
| solution | Borate response (mm) | Resolution (R)^{c} |
| Mannitol | 63.6 | 1.42 |
| Sorbitol | 85.0 | 1.70 |
| Erythritol | 21.4 | 1.35 |
| Glycerol | 13.2 | 1.27 |
| Pentaerythritol | 32.0 | 1.46 |

At the cation removing step (C6), a small amount of cations still remaining in the sample are removed. The sample rinsed as described above moves to the anion suppressor 11 by the MSA, which is eluent supplied from the eluent supplier 7, and the sorbitol, which is an additive. The anion suppressor 11 removes small amounts of cations such as hydrazine (N₂H₄), ammonia (NH₃), ethanolamine (ETA, NH₂CH₂CH₂OH) and the like which are not removed in the rinsing process and still remain in the sample, decreases the level of high baseline of the eluent, and enhances sensitivity of detecting the boron ions.

At the conductivity measurement step (C7), conductivity of the boron ions in the sample processed as described above is measured using the conductivity detector 12.

At the analysis and evaluation step (S4), concentration of the boron ions, leakage symptoms of the steam generator tube and a leak rate thereof are evaluated by analyzing and comparing the conductivity measured using the ion chromatography with the reference value, using a Programmable Logic Controller (PLC) for analyzing and calculating a leak rate derived in the present invention.

If a data analysis and control computer is added to the system for detecting boron ions using ion chromatography for online monitoring of steam generator tube leakage in a light water reactor of the present invention as described above and, at the same time, a control program for programming and automatically controlling the entire monitoring process, such as a Programmable Logic Controller for supplying and transferring a sample, operating each device, analyzing data and calculating a leak rate, is provided in the data analysis and control computer, leakage of the primary side coolant to the secondary side through the steam generator tube and its leak rate can be monitored online in real-time, and manpower of analysis and amounts of wastes can be minimized.

In addition, if it is configured such that the data analysis and control computer stores and manages the collected data and provides analysis data such as a concentration and a leak rate of the boron ions to a water quality management system of a nuclear power plant and the water quality management system transmits related information to a power plant central monitoring system and, at the same time, if an error occurs, automatically notifies the error to a person in charge through a web or a mobile communication, it is possible to promptly take an action needed for leakage of the steam generator.

Meanwhile, equations and processes of the present invention for inducing a leak rate are described below.

According to the law of conservation of mass, if a mass is changed before and after a response, a removed or processed amount exists somewhere. In the case of boron ions which are a nonradioactive material, constants presented from the field of a power plant should be substituted in a mass balance equation in order to correct amounts of loss of adsorption and hideout in the steam generator and a difference of amount physically removed through the blowdown, and every power plant has different constants. FIG. 5 is a view showing a mass transport phenomenon of a chemical species assuming a steam generator as a boundary condition, and a difference of mass is generated because of leakage of boron ions from the primary side to the secondary side and the blowdown. If a Continuous Stirred Tank Reactor (CSTR) is assumed, in which an amount of flow leaking from a tube is equal to an amount of flow leaked to outside of a steam generator since a fluid (water) is incompressible, a mass balance equation related to boron ions can be expressed as Eq. 1.

$$V \frac{d C}{d t} = {QC}_{L} \pm {V ( \frac{d C}{d t} )}_{\begin{matrix}adsorption \\ hideout\end{matrix}} \pm {V ( \frac{d C}{d t} )}_{decay} - {Q}_{R} C + {Q}_{B} {C}_{B} \qquad Eq . 1$$

A part related to decay constants considering a mass for collapsing radionuclides, proposed by the EPRI, can be eliminated since it does not correspond to a mass balance equation of a chemical species. In addition, in Eq. 1, ‘Q_{B}C_{B}’ is a mass of supply water supplied to the steam generator as much as the physical removal generated by the blowdown, and since concentration of the boron ions included therein is ‘0’, a finally equation considering this is Eq. 2.

$$V \frac{d C}{d t} = {QC}_{L} \pm {V ( \frac{d C}{d t} )}_{\begin{matrix}adsorption \\ hideout\end{matrix}} - {Q}_{R} C \qquad Eq . 2$$

Eq. 2 can be expressed as Eq. 3 if it is differentiated assuming the hideout as a first order. Table 2 shows definitions of variables of Eq. 3.

$$V \frac{d C}{d t} = {QC}_{L} - kCV - {Q}_{R} C \qquad Eq . 3$$

TABLE 2

| | |
|---|---|
| V | Mass of liquid water in steam generator, L |
| C | Concentration of Boron in the secondary system, mg/L |
| C_{L} | Concentration of Boron in the primary system, mg/L |
| k | Constant to account for adsorption/hideout on plant surface, |
| | hr⁻¹ |
| Q | Flow rate of into steam generator, L/hr |
| Q_{R} | Flow rate of physical removal term such as blowdown or leak |
| | rate out of steam generator, L/hr |

On the other hand. Eq. 3 is transformed into Eq. 4 shown below, which is a first order linear ordinary differential equation.

$$\begin{matrix}{VC}^{′} = {QC}_{L} - ( kCV - {Q}_{R} ) C \\ {VC}^{′} + ( kV + {Q}_{R} ) C = {QC}_{L} & Eq . 4 \\ {C}^{′} + ( k + \frac{{Q}_{R}}{V} ) C = \frac{Q}{V} {C}_{L} & Eq . 5\end{matrix}$$

If a differential and integral equation of a C′+P(t)C=Q(t)C_{L} form is rearranged by substituting an integration factor (IF)

$$IF = {e}^{\int \frac{{Q}_{R} + kV}{V}}$$

in this equation,

$${C}^{′} \cdot {e}^{\int \frac{{Q}_{R} + kV}{V} d t} + ( \frac{{Q}_{R} + kV}{V} ) C \cdot {e}^{\int \frac{{Q}_{R} + kV}{V} d t} = \frac{Q}{V} {C}_{L} \cdot {e}^{\int \frac{{Q}_{R} + kV}{V} d t}$$

$$\int {[ C \cdot {e}^{\int \frac{{Q}_{R} + kV}{V} d t} ]}^{′} = \int \frac{{QC}_{L}}{V} {e}^{\int \frac{{Q}_{R} + kV}{V} d t}$$

$$C \cdot {e}^{\int \frac{{Q}_{R} + kV}{V} d t} = \int \frac{{QC}_{L}}{V} {e}^{\int \frac{{Q}_{R} + kV}{V} d t} d t + {C}_{0}$$

$$C ( t ) = {C}_{0} \cdot {e}^{\int \frac{{Q}_{R} + kV}{V} d t} + {e}^{- \int \frac{{Q}_{R} + kV}{V} d t} \cdot \int \frac{{QC}_{L}}{V} {e}^{\int \frac{{Q}_{R} + kV}{V} d t} d t .$$

Here, if it is assumed that

$$\frac{{Q}_{R} + kV}{V} = k + \frac{{Q}_{R}}{V} = α , \\ \begin{matrix}{C}_{( t )} = {C}_{0} \cdot {e}^{- \int α d t} + {e}^{- \int α d t} \cdot \int \frac{{QC}_{L}}{V} {e}^{\int α d t} d t \\ = {C}_{0} \cdot {e}^{- α t} + {e}^{- α t} \int \frac{{QC}_{L}}{V} {e}^{α t} d t \\ = {C}_{0} \cdot {e}^{- α t} + \frac{{QC}_{L}}{V} {e}^{- α t} \int {e}^{α t} d t \\ = {C}_{0} \cdot {e}^{- α t} + \frac{{QC}_{L}}{V} {e}^{- α t} [ \frac{1}{α} {e}^{α t} - \frac{1}{α} ] \\ = {C}_{0} \cdot {e}^{- α t} + ( \frac{{QC}_{L}}{α V} - \frac{{QC}_{L}}{α V} {e}^{- α t} )\end{matrix} \\ ∴ {C}_{( t )} = \frac{{QC}_{L}}{α V} ( 1 - {e}^{- α t} ) + {C}_{0} {e}^{- α t} . \qquad Eq . 6$$

Here, if t=1 and 2 are substituted to eliminate the integration constant C₀, which is an unknown,

$${C}_{1} = \frac{{QC}_{L}}{α V} ( 1 - {e}^{- α {t}_{1}} ) + {C}_{0} {e}^{- α {t}_{1}}$$

when t=t1, and

$${C}_{2} = \frac{{QC}_{L}}{α V} ( 1 - {e}^{- α {t}_{2}} ) + {C}_{0} {e}^{- α {t}_{2}}$$

when t=t2.

If these two equations are rearranged in the form of C₀,

$${C}_{0} = \frac{{C}_{1} - \frac{{QC}_{L}}{α V} ( 1 - {e}^{- α {t}_{1}} )}{{e}^{- α {t}_{1}}} = \frac{{C}_{2} - \frac{{QC}_{L}}{α V} ( 1 - {e}^{- α {t}_{2}} )}{{e}^{- α {t}_{2}}} \\ [ {C}_{1} = \frac{{QC}_{L}}{α V} ( 1 - {e}^{- α {t}_{1}} ) ] \times {e}^{- α {t}_{2}} = [ {C}_{2} = \frac{{QC}_{L}}{α V} ( 1 - {e}^{- α {t}_{2}} ) ] \times {e}^{- α {t}_{1}}$$

$${C}_{1} \times {e}^{- α {t}_{2}} - \frac{{QC}_{L}}{α V} ( 1 - {e}^{- α {t}_{1}} ) \times {e}^{- α {t}_{2}} = {C}_{2} \times {e}^{- α {t}_{1}} - \frac{{QC}_{L}}{α V} ( 1 - {e}^{- α {t}_{2}} ) \times {e}^{- α {t}_{1}}$$

$$\begin{matrix}{C}_{2} \times {e}^{- α {t}_{1}} - {C}_{1} \times {e}^{- α {t}_{2}} = \frac{{QC}_{L}}{α V} ( 1 - {e}^{- α {t}_{2}} ) \times {e}^{- α {t}_{1}} - \\ \frac{{QC}_{L}}{α V} ( 1 - {e}^{- α {t}_{1}} ) \times {e}^{- α {t}_{2}} \\ = \frac{{QC}_{L}}{α V} ( \begin{matrix}{e}^{- α {t}_{1}} - {e}^{- α {t}_{2}} \times {e}^{- α {t}_{1}} - \\ {e}^{- α {t}_{2}} + {e}^{- α {t}_{1}} \times {e}^{- α {t}_{2}}\end{matrix} ) \\ = \frac{{QC}_{L}}{α V} ( {e}^{- α {t}_{1}} - {e}^{- α {t}_{2}} )\end{matrix}$$

If both sides are divided by e^{-αt}^{₁},

$${C}_{2} - {C}_{1} \times \frac{{e}^{- α {t}_{2}}}{{e}^{- α {t}_{1}}} = \frac{{QC}_{L}}{α V} ( \frac{{e}^{- α {t}_{1}}}{{e}^{- α {t}_{1}}} - \frac{{e}^{- α {t}_{2}}}{{e}^{- α {t}_{1}}} ) \\ {C}_{2} - {C}_{1} \times {e}^{- α ( {t}_{2} - {t}_{1} )} = \frac{{QC}_{L}}{α V} [ 1 - {e}^{- α ( {t}_{2} - {t}_{1} )} ] . \qquad Eq . 7$$

If Eq. 7 is rearranged for Q, an equation of Eq. 8 can be obtained. Eq. 8 is obtained by transforming mass balance equations Eqs. 1, 2 and 3 related to the boron ions into the form of a first order linear ordinary differential equation and setting and substituting an integration factor (IF) to simplify the equations for a general solution of the differential equation. Then, a leak rate calculating equation is derived by substituting time t=1 and 2 to eliminate the unknown C₀. This equation may be applied to lithium ions in the same way. Next, Table 3 shows definitions of variables in leak equation Eq. 8 targeting the boron ions, which are nonradionuclides.

$$∴ Q = \frac{{C}_{2} - {C}_{1} {e}^{- α ( {t}_{2} - {t}_{1} )}}{1 - {e}^{- α ( {t}_{2} - {t}_{1} )}} \times \frac{α V}{{C}_{L}} = \frac{( {C}_{2} - {C}_{1} {e}^{- αΔ t} ) α V}{( 1 - {e}^{- αΔ t} ) {C}_{L}} \qquad Eq . 8$$

TABLE 3

| | |
|---|---|
| Q | Flow rate of into steam generator, L/hr |
| C | Concentration of Boron in the secondary system, mg/L |
| | (C₁ = 0, at t = 0) |
| C_{L} | Concentration of Boron in the primary system, mg/L |
| Δt | Setting value according to analysis intervals, hr |
| α | $α = κ + \frac{{Q}_{R}}{V} ,$ |
| | Setting value according to plants, hr⁻¹ |
| k | Constant to account for adsorption/hideout on plant surface, |
| | hr⁻¹ |
| Q_{R} | Flow rate of physical removal term such as blowdown or leak |
| | rate out of steam generator, L/hr |
| V | Mass of liquid water in steam generator, L |

In addition, the equation for boron ions leaking into the secondary side steam generator can be transformed into Eq. 9 through Eq. 8.

$${C}_{2} = {C}_{1} \times {e}^{- α ( {t}_{2} - {t}_{1} )} + \frac{{QC}_{L}}{α V} [ 1 - {e}^{- α ( {t}_{2} - {t}_{1} )} ] \qquad Eq . 9$$

In the present invention, an anion separation column does not need to be installed in the ion chromatography, and since concentration of boron ions can be measured in an environment in which concentration of the boron ions is extremely low as much as 0.3 ppb (5 ppb before the present invention) or a rate of leaking to the secondary side tube is 5 GPD by employing a boron trapping column optimized for trapping an extremely small amount of boron ions, measurement sensitivity can be enhanced about sixteen times compared with that of conventional ion chromatography.

Although the ion chromatography of the present invention needs a long rinsing time to eliminate impurities of all kinds of ions other than boron ions in the sample, an analysis time can be reduced to less than 10 minutes per analysis since only the boron trapping column is used without an anion separation column.

In addition, since the ion chromatography of the present invention uses only one boron trapping column and does not use other columns, operation pressure can be lowered to a level of one tenth of that of conventional ion chromatography, and thus maintenance is convenient, and durability is improved.

The present invention is effective in that since concentration of an extremely small amount of boron ions can be accurately detected in an environment in which concentration of leaked boron ions is 0.3 ppb level or a rate of leaking to the secondary side tube is 5 GPD (Gallon Per Day) by employing a boron trapping column optimized for trapping an extremely small amount of boron ions, a microscopic defect of a steam generator tube can be detected in early stage, and a leak rate can be accurately grasped.

The present invention is effective in that maintenance is convenient and durability is improved since analysis time is reduced considerably and operation pressure is lowered greatly by using ion chromatography provided with a boron trapping column optimized for trapping an extremely small amount of boron ions and a deionization water supplier for rising a sample line, instead of general ion chromatography provided with a concentration column and a separation column, and in addition, the problem of overlapping the boron ions with fluoride and other anions is solved by using sorbitol, which is a new polyhydric alcohol, instead of conventional mannitol, as an additive for amplifying conductivity of boron.

The present invention is effective in that since the boron ions, i.e., chemical species, not radionuclides, contained in the coolant of a reactor are used an a leakage indicator of a steam generator tube, leakage of the steam generator tube can be monitored regardless of the output power of the reactor.

While the present invention has been described with reference to example embodiments, it will be apparent to those skilled in the art that various changes and modifications may be made without departing from the spirit and scope of the present invention. Therefore, it should be understood that the above embodiments are not limiting, but illustrative.

In addition, detailed descriptions of the present invention and reference numerals specified in the claims are additionally described for reference to make the present invention easily understood, and the present invention is not limited to the forms in the drawings.

1. A boron ion detecting system for monitoring steam generator tube leakage in a light water reactor, the system comprising:
a sample line for injecting and flowing a sample,
pre-treatment filters for removing particulate foreign matters in the sample,
pressure sensors for determining saturation of the pre-treatment filters,
a flowmeter for monitoring a flow speed and a flow rate of the sample flowing through the sample line,
ion chromatography for measuring conductivity of the sample, being provided with a boron trapping column optimized for trapping an extremely small amount of boron ions and a deionization water supplier for rinsing the sample line, and
a sample container for controlling a flow speed and a flow rate of the sample flowing into the ion chromatography.

2. The system according to claim 1, wherein the ion chromatography includes:
a sample supplier for supplying the sample,
a standard solution supplier for supplying a standard solution,
a deionization water supplier for supplying deionized water,
sample pumps and sample valves for supplying the sample, the standard solution and the deionized water,
a 10-port valve and inline filters for removing particulate foreign matters of fine particles in the sample,
a 6-port valve and a boron trapping column for trapping and concentrating boron ions in the sample,
an eluent supplier and an eluent pump for supplying eluent for promoting transfer of the sample,
a deionization water supplier and a deionization water pump for rinsing impurities of all kinds of ions, other than the boron ions, remaining in the sample line,
an anion suppressor for easily detecting the boron ions by removing residual cations, lowering conductivity of the eluent and increasing conductivity of the sample,
a conductivity detector for detecting conductivity of the boron ions in the sample, and
waste lines for exhausting waste fluids.

3. A boron ion detecting method for monitoring steam generator tube leakage in a light water reactor, the method comprising:
a sample injection step (S1) of injecting a sample into the system,
a sample pre-treatment step (S2) of removing particulate foreign matters in the injected sample,
a conductivity measurement step (S3) of measuring conductivity of the boron ions using ion chromatography provided with a boron trapping column optimized for trapping an extremely small amount of boron ions and a deionization water supplier for rinsing the sample line, and
an analysis and evaluation step (S4) of calculating concentration of the boron ions, detecting symptoms of leakage of the steam generator tube, and calculating a leak rate by analyzing the measured conductivity.

4. The method according to claim 3, wherein the process of measuring conductivity of the boron ions using the ion chromatography at the conductivity measurement step (S3) includes
a sample flow-in step (C1),
an automatic filtering step (C2) of automatically removing particulate foreign matters of fine particles in the flowed-in sample,
a boron ion trapping step (C3) of concentrating only the boron ions in the flowed-in sample,
a sample line rinsing step (C4) of removing impurities of all kinds of ions other than the boron ions by rinsing the sample line,
an eluent injecting step (C5) of dissociating the trapped boron ions and pushing the dissociated boron ions into a suppressor and a conductivity detector,
a cation removing step (C6) of removing a small amount of cations still remaining in the sample, and
a conductivity measurement step (C7) of measuring conductivity of the boron ions in the processed sample.

5. The method according to claim 4, wherein at the sample line rinsing step (C4), the deionization water pump 8d is configured of a micro pump having a flow rate of 1 to 5 mL/min, and the sample line is rinsed for about 1 to 5 minutes.

6. The method according to claim 4, wherein at the eluent injecting step (C5), methane sulfonic acid (MSA) is used as eluent, and sorbitol is added.

7. The method according to claim 6, wherein the methane sulfonic acid (MSA) is injected into the boron trapping column in a concentration range of 1 to 5 mM.

8. The method according to claim 6, wherein the methane sulfonic acid (MSA) is injected into the boron trapping column in a concentration range of 2.5 mM or less.

9. The method according to claim 6, wherein the sorbitol is injected in a concentration range of 20 to 40 g/L.

10. The method according to claim 3, wherein at the sample line rinsing step (C4), a leak rate is calculated using a following equation
$$∴ Q ( leakrate ) = \frac{{C}_{2} - {C}_{1} {e}^{- α ( {t}_{2} - {t}_{1} )}}{1 - {e}^{- α ( {t}_{2} - {t}_{1} )}} \times \frac{α V}{{C}_{L}} ,$$
here,
Q: Leak rate, L/hr
C: Concentration of boron ions of secondary side, mg/L (C₁=0, at t=0)
C_{L}: Concentration of boron ions of primary side, mg/L
α:
$$α = k + \frac{{Q}_{R}}{V} ,$$
unique value of power plant, hr⁻¹
k: Constants of adsorption and hideout, hr⁻¹
Q_{R}: Amount of blowdown, L/hr
V: Volume of steam generator, L, wherein
volume of water of the steam generator is obtained from a volume change curve according to change of water level of the steam generator, and a blowdown rate of the steam generator or a blowdown rate of a downcomer is constant.

11. The method according to claim 3, wherein leakage of a primary side coolant to a secondary side through the steam generator tube and its leak rate can be monitored online in real-time, and manpower of analysis and amounts of wastes can be minimized, by adding a data analysis and control computer and, at a same time, providing a control program for programming and automatically controlling an entire monitoring process, such as a Programmable Logic Controller for supplying and transferring a sample, operating each device, analyzing data and calculating a leak rate, in the data analysis and control computer.

12. The method according to claim 11, wherein an action needed for leakage of the steam generator can be promptly taken by configuring such that the data analysis and control computer stores and manages the collected data and provides analysis data such as a concentration and a leak rate of the boron ions to a water quality management system of a nuclear power plant, and the water quality management system transmits related information to a power plant central monitoring system and, at the same time, if an error occurs, automatically notifies the error to a person in charge through a web or a mobile communication.

13. The method according to claim 4, wherein leakage of a primary side coolant to a secondary side through the steam generator tube and its leak rate can be monitored online in real-time, and manpower of analysis and amounts of wastes can be minimized, by adding a data analysis and control computer and, at a same time, providing a control program for programming and automatically controlling an entire monitoring process, such as a Programmable Logic Controller for supplying and transferring a sample, operating each device, analyzing data and calculating a leak rate, in the data analysis and control computer.

14. The method according to claim 13, wherein an action needed for leakage of the steam generator can be promptly taken by configuring such that the data analysis and control computer stores and manages the collected data and provides analysis data such as a concentration and a leak rate of the boron ions to a water quality management system of a nuclear power plant, and the water quality management system transmits related information to a power plant central monitoring system and, at the same time, if an error occurs, automatically notifies the error to a person in charge through a web or a mobile communication.

15. The method according to claim 10, wherein leakage of a primary side coolant to a secondary side through the steam generator tube and its leak rate can be monitored online in real-time, and manpower of analysis and amounts of wastes can be minimized, by adding a data analysis and control computer and, at a same time, providing a control program for programming and automatically controlling an entire monitoring process, such as a Programmable Logic Controller for supplying and transferring a sample, operating each device, analyzing data and calculating a leak rate, in the data analysis and control computer.

16. The method according to claim 15, wherein an action needed for leakage of the steam generator can be promptly taken by configuring such that the data analysis and control computer stores and manages the collected data and provides analysis data such as a concentration and a leak rate of the boron ions to a water quality management system of a nuclear power plant, and the water quality management system transmits related information to a power plant central monitoring system and, at the same time, if an error occurs, automatically notifies the error to a person in charge through a web or a mobile communication.
